(19) United States
(12) Patent Application Publication
(10) Pub. No.: US 2002/0051410 A1
(43) Pub. Date: May 2, 2002

(54) Focus search apparatus and focus search method

(75) Inventor: Hiroaki Okajima, Chiba (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: SONY CORPORATION, Tokyo (JP)

(21) Appl. No.: 09/984,998

(22) Filed: Nov. 1, 2001

(30) Foreign Application Priority Data
Nov. 2, 2000 (JP) P2000-336079

(51) Int. Cl. G11B 7/095

(52) U.S. Cl. 369/44.27

(57) ABSTRACT

The invention provides a focus search apparatus and a focus search method by which damage to an objective lens of an optical pickup or an optical recording medium upon a focus search can be prevented at a low cost. The optical pickup is driven in a focusing direction with a gradually increasing amplitude, and the driving is stopped when the optical pickup reaches a range within which focus servoing is possible. Since the amplitude of the driving exhibits a gradual increase, even if the optical pickup is driven over several periods in an initial stage of the focus search, the amplitude of the driving then is still small. Since the optical pickup has a number of opportunities in which it can reach the range within which focus servoing is possible equal to the number of periods, the possibility that the optical pickup may collide with the optical recording medium is low.

### BACKGROUND OF THE INVENTION

This invention relates to a focus search apparatus and a focus search method for moving, prior to focus servoing of an optical pickup with respect to an optical recording medium, the optical pickup to a range within which such focus servoing is possible.

FIG. 3 shows a general configuration of an optical disk recording and/or playback apparatus. Referring to FIG. 3, the optical disk recording and/or apparatus 11 includes a rotating mechanism 13 into which an optical disk 12 such as a compact disk, a mini disc or a digital versatile disk is loaded, and an optical pickup 14 positioned below the optical disk 12 loaded in position. The optical pickup 14 includes a driving mechanism 15 and an objective lens 16, and a driving circuit 18 controlled by a control section 17 supplies a signal for driving the optical pickup 14 to the driving mechanism 15.

In order for the optical pickup 14 to record or play back a signal onto or from the optical disk 12, the optical pickup 14 must be controlled by focus servoing by the driving mechanism 15. If the optical pickup 14 is positioned in the proximity of a focused position for the optical disk 12, then an S-shaped focus error signal is obtained from the optical pickup 14, and if the optical pickup 14 is positioned within a range corresponding to a range between a maximum value and a minimum value of the S-shaped focus error signal, then focus servoing for the optical pickup 14 is possible.

Therefore, in order to perform focus servoing for the optical pickup 14, it is necessary to move, prior to the focus servoting, the optical pickup 14 to a position within the range within which the focus servoing is possible, that is, to pull the optical pickup 14 into the range corresponding to the range between the maximum value and the minimum value of the S-shaped focus error signal. This operation is called a focus search.

FIG. 4 shows a voltage waveform of a signal supplied from the driving circuit 18 to the driving mechanism 15 under the control of the control section 17 upon a focus search of the conventional optical disk recording and/or apparatus 11. A triangular wave portion of the waveform of FIG. 4 is a signal for driving the optical pickup 14 in a focusing direction in order to perform the focus search. If a signal of an initial voltage indicated in the proximity of the point of time of 0 in FIG. 4 is supplied to the driving mechanism 15, then the driving mechanism 15 does not generate driving force in the focusing direction.

If a signal or a voltage lower than the initial voltage is supplied to the driving mechanism 15, then the driving mechanism 15 generates driving force for moving the optical pickup 14 downwardly away from the optical disk 12. As the voltage becomes lower, higher driving force is generated to move the optical pickup 14 away from the optical disk 12. on the other hand, it a signal of a voltage higher than the reference is supplied to the driving mechanism 15, then the driving mechanism 15 generates driving force for moving the optical pickup 14 upwardly toward the optical disk 12, and as the voltage becomes higher, higher driving force is generated to move the optical pickup 14 toward the optical disk 12.

The focus search in almost all cases wins a success with a signal of the first cycle. An irregular portion of the waveform of FIG. 4 following the triangular wave portion is a signal for focus servoing after the success in the focus search. However, if the optical disk recording and/or apparatus 11 is, for example, of the vehicle-carried type and vibrations are applied to the optical pickup 14 accidentally upon the focus search or accidentally some dust sticks to or damage is present on a portion of the optical disk 12 at which the focus search is performed, then the focus search may result in failure with a signal of the first cycle.

In this instance, a signal of several periods is supplied from the driving circuit 18 to the driving mechanism 15 as seen in FIG. 4 to repeat the focus search. However, if the focus search does not win a success within a predetermined period of time, then the control section 17 controls the driving circuit 18 to stop the supply of the signal to stop the focus search. As can be seen apparently from the voltage waveform at the triangular wave portion shown in FIG. 4, both of the amplitude and the period of the signal for the focus search in the conventional optical disk recording and/or apparatus 11 are fixed.

By the way, if the amplitude of the signal for the focus search is insufficient, then also the driving force generated by the driving mechanism 15 is insufficient, and the optical pickup 14 cannot be pulled into the range corresponding to the range of the S-shaped focus error signal between the maximum value and the minimum value, resulting in failure in the focus search. On the other hand, the optical pickup 14, driving circuit 18 and so forth have individual differences, and the operation state of the optical pickup 14, driving circuit 18 and so forth varies depending also upon the environmental temperature, secular change and so forth.

From the foregoing, where the conventional optical disk recording and/or apparatus 11 is produced in a mass, taking individual differences, various environments, the secular change and so forth into consideration, the amplitude of the signal for the focus search is set rather great so that the focus search may be performed with certainty with all of the mass-produced optical disk recording and/or apparatus 11.

Where the optical disk recording and/or apparatus 11 has a comparatively great thickness, since the objective lens 16 has a long focal length, even if the amplitude of the signal for the focus search is set rather great as described hereinabove, the objective lens 16 does not collide with the optical disk 12 upon the focus search. However, where the optical disk recording and/or apparatus 11 has a reduced thickness as those in recent years, the objective lens 16 has a shorter focal length.

Therefore, if the focus search does not win a success with a signal for the first cycle and then is performed successively over the signal for several succeeding periods, then with the conventional individual optical disk recording and/or apparatus 11 there is the possibility that the objective lens 16 may collide with the optical disk 12 at a portion of the waveform of the signal which is indicated by an ellipse of an alternate long and short dash line in FIG. 4. Accordingly, in the conventional optical disk recording and/or apparatus 11, there is the possibility that the objective lens 16 or the optical disk 12 may be damaged upon the focus search.

Further, as can be seen apparently from FIG. 4, since the signal for the focus search oscillates from the maximum value to the minimum value in any period, if the inclination of the signal is fixed, then one period is long and the frequency is low. Therefore, the opportunity in which the optical pickup 14 is pulled into a state which allows focus servoing does not appear particularly frequently in an initial stage of the focus search, and the focus search is not always completed in a short time.

Furthermore, since the period of the signal for the focus search is fixed, if standing oscillations by an engine of an automobile or the like are applied to the optical pickup 14 and the period of the oscillations overlaps the period of the signal for the focus search, then the optical pickup 14 continues to be hindered from being pulled into the range in which focus servoing is possible. Therefore, the focus search is not necessarily performed stably.

A method of preventing such collision between the objective lens 16 and the optical disk 12 to prevent possible damage to them is disclosed, for example, in Japanese Patent Laid-Open No. Hei 11-120599. According to the disclosed method, a focus search is executed using a flat optical disk for reference to measure and store a voltage of a signal then, and upon the focus search, a signal having a voltage higher than a voltage obtained by adding an estimated value to the stored value is not supplied.

Another method is disclosed, for example, in Japanese Patent Laid-Open No. Hei 7-93760 wherein, when an optical pickup moves to a position in the proximity of a focused position toward an optical disk upon a focus search, a signal having a voltage for moving the optical pickup away from the optical disk is supplied so that, even if the focus search does not win a success, collision between an objective lens and the optical disk is prevented.

However, the method disclosed in Japanese Patent Laid-Open No. Hei 11-120599 requires means for measuring the voltage of a signal and means for storing the measurement value. Also the method disclosed in Japanese Patent Laid-Open No. Hei 7-93760 requires means for generating a signal having a reference voltage, means for detecting that the optical pickup comes to a position in the proximity of a focused position, and means for generating a signal having a voltage for moving the optical pickup away from an optical disk.

Therefore, it is difficult to use any of the two methods described above to prevent damage to the objective lens of the optical pickup and an optical disk upon the focus search with a low cost.

### SUMMARY OF THE INVENTION

It is an object of the present invention to provide a focus search apparatus and a focus search method by which damage to an objective lens of an optical pickup or an optical recording medium upon a focus search can be prevented at a low cost.

In order to attain the object described above, according to an aspect of the present invention, there is provided a focus search apparatus, including signal generation means for generating a signal having a gradually increasing amplitude, driving means for receiving the signal from the signal generation means and driving an optical pickup in a focusing direction toward an optical recording medium in response to the amplitude of the received signal, and control means for normally allowing the signal to be supplied from the signal generation means to the driving means and for discriminating whether or not the optical pickup is driven by the driving means to move into a range within which focus servoing Is possible and stopping the supply of the signal from the signal generation means to the driving means if the control means discriminate that the optical pickup has moved into the range.

In the focus search apparatus, since the amplitude of the signal for driving the optical pickup exhibits a gradual increase, even if the driving means drives the optical pickup over several periods in an initial stage of a focus search, the amplitude of the driving of the optical pickup then is still small. Since the optical pickup has a number of opportunities in which it can reach the range within which focus servoing is possible equal to the number of periods, the possibility that the optical pickup may collide with the optical recording medium upon the focus search is low. Consequently, otherwise possible damage to the objective lens of the optical pickup or the optical recording medium upon the focus search can be prevented.

Besides, since such gradual increase of the amplitude of the signal for driving the optical pickup as described above can be achieved only by modification to the pertaining software employed by the control section, there is no necessity to additionally include a new part used for execution of such a focus search as described above. Consequently, such prevention or damage to the objective lens of the optical pickup or the optical recording medium upon the focus search can be achieved at a low cost.

Preferably, the amplitude has a maximum value determined therefor so as to correspond to a maximum distance between the optical pickup and the optical recording medium upon starting of the driving. Where the maximum value of the amplitude is determined in this manner, otherwise possible collision between the optical pickup and the optical recording medium upon the focus search is prevented. Consequently, otherwise possible damage to the objective lens of the optical pickup or the optical recording medium upon the focus search can be prevented with certainty.

Preferably, the signal has a gradually increasing period. Where the signal has a gradually increasing period in this manner, the frequency of the signal is comparatively high in an initial stage of the focus search and the number of opportunities in which the optical pickup reaches the range within which focus servoing is possible is particularly great in the initial stage of the focus search. Consequently, the focus search is performed in a short time. Further, since the period of the signal for driving the optical system gradually increases, even if standing vibrations are applied to the optical pickup, as the time passes, the period of the vibrations and the period of the signal go out of an overlapping condition, and therefore, such a situation that the optical pickup is hindered from reaching the range within which focus servoing is possible does not continue for a long time. Furthermore, even if the amplitude of the signal for driving the optical pickup gradually increases, since also the period of the signal gradually increases, an increase of the driving speed which may be caused by the gradual increase of the amplitude of the signal is suppressed, and such a situation that conversely it becomes difficult for the optical pickup to reach the range within which focus servoing is possible as the focus search proceeds does not occur. Consequently, the focus search is performed stably.

According to another aspect of the present invention, there is provided a focus search method, including the steps of driving an optical pickup in a focusing direction toward an optical recording medium with a gradually increasing amplitude, and stopping the driving when the optical pickup reaches a range within which focus servoing is possible as a result of the driving.

In the focus search method, since the amplitude of the driving of the optical pickup exhibits a gradual increase, even if the driving means drives the optical pickup over several periods in an initial stage of a focus search, the amplitude of the driving of the optical pickup then is still small. Further, since the optical pickup has a number of opportunities in which it can reach the range within which focus servoing is possible equal to the number of periods, the possibility that the optical pickup may collide with the optical recording medium upon focus search is low. Consequently, otherwise possible damage to the objective lens of the optical pickup or the optical recording medium upon the focus search can be prevented.

Besides, since such gradual increase of the amplitude of the driving the optical pickup as described above can be achieved only by modification to the pertaining software employed by the control section, there is no necessity to additionally include a new part used for execution of such a focus search as described above. Consequently, such prevention of damage to the objective lens of the optical pickup or the optical recording medium upon the focus search can be achieved at a low cost.

Preferably, the amplitude has a maximum value determined therefor so as to correspond to a maximum distance between the optical pickup and the optical recording medium upon starting of the driving. Where the maximum value of the amplitude is determined in this manner, otherwise possible collision between the optical pickup and the optical recording medium upon a focus search is prevented with certainty. Consequently, otherwise possible damage to the objective lens of the optical pickup or the optical recording medium upon the focus search can be prevented with certainty.

Preferably, the signal has a gradually increasing period. Where the signal has a gradually increasing period in this manner, the frequency of the signal is comparatively high in an initial stage of a focus search and the number of opportunities in which the optical pickup reaches the range within which focus servoing is possible is particularly great in the initial stage of the focus search. Consequently, the focus search is performed in a short time. Further, since the period of the signal for driving of the optical system gradually increases, even if standing vibrations are applied to the optical pickup, as the time passes, the period of the vibrations and the period of the signal go out of an overlapping condition, and therefore, such a situation that the optical pickup is hindered from reaching the range within which focus servoing is possible does not continue for a long time. Furthermore, even if the amplitude of the driving of the optical pickup gradually increases, since also the period of the signal gradually increases, an increase of the driving speed which may be caused by the gradual increase of the amplitude of the driving is suppressed, and such a situation that conversely it becomes difficult for the optical pickup to reach the range within which focus servoing is possible as the focus search proceeds does not occur. Consequently, the focus search is performed stably.

According to a further aspect of the present invention, there is provided an optical disk recording and/or playback apparatus, including signal generation means for generating a signal having a gradually increasing amplitude, driving means for receiving the signal from the signal generation means and driving an optical pickup in a focusing direction toward an optical recording medium in response to the amplitude of the received signal, and control means for normally allowing the signal to be supplied from the signal generation means to the driving means and for discriminating whether or not the optical pickup is driven by the driving means to move into a range within which focus servoing is possible and stopping the supply of the signal from the signal generation means to the driving means if the control means discriminate that the optical pickup has moved into the range.

Preferably, the amplitude has a maximum value determined therefor so as to correspond to a maximum distance between the optical pickup and the optical recording medium upon starting of the driving.

Preferably, the signal has a gradually increasing period.

Also with the optical disk recording and/or playback apparatus, similar advantages to those of the focus search apparatus can be anticipated.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a graph illustrating a voltage waveform of a signal for a focus search and a following signal for focus servoing used by a focus search apparatus and a focus search method according to the present invention;

FIG. 2 is a flow chart illustrating a procedure of the focus search used in the focus search apparatus and the focus search method according to the present invention;

FIG. 3 is a schematic block diagram of an optical disk recording and/or playback apparatus to which the present invention can be applied; and

FIG. 4 is a graph illustrating a voltage waveform of a signal for the focus search and a following signal for focus servoing used in a conventional optical disk recording and/or playback apparatus.

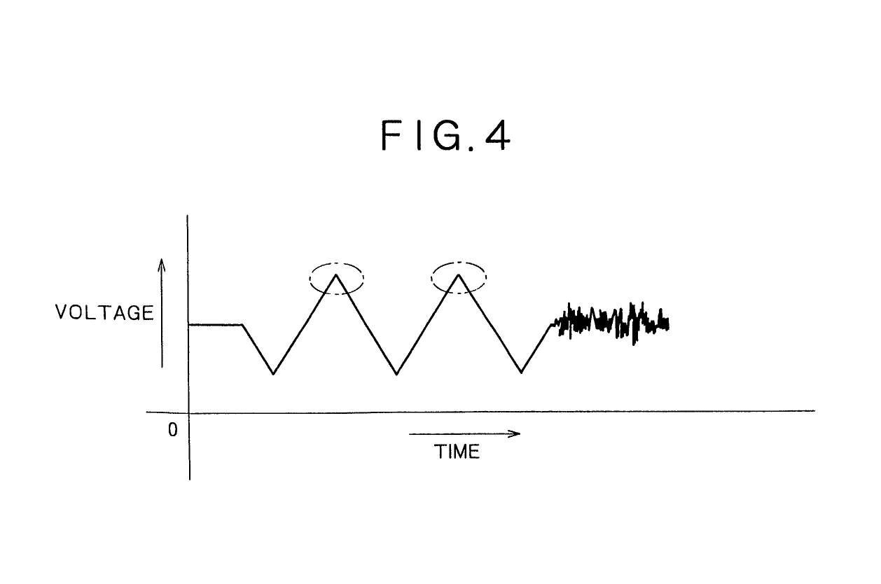

### DETAILED DESCRIPTION OF THE PREFERRED EMBODIMENT

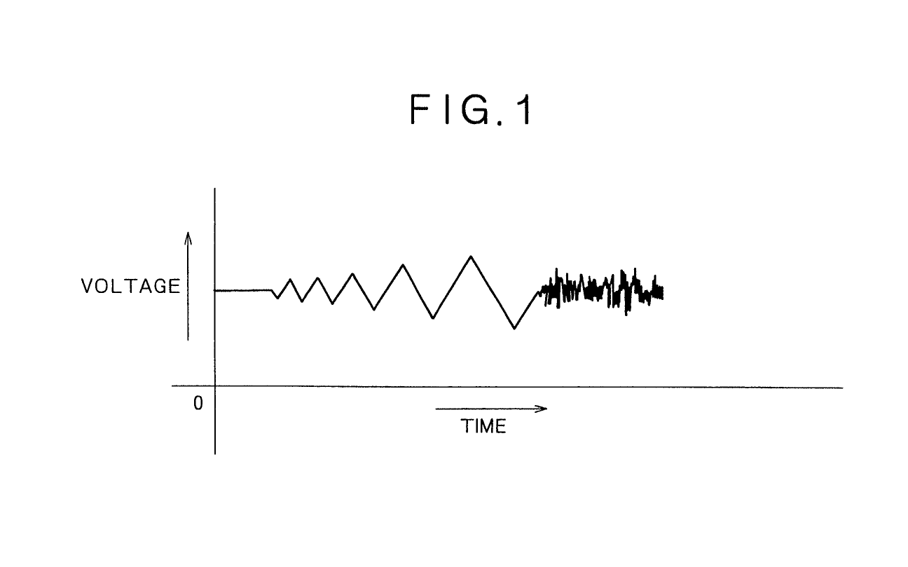

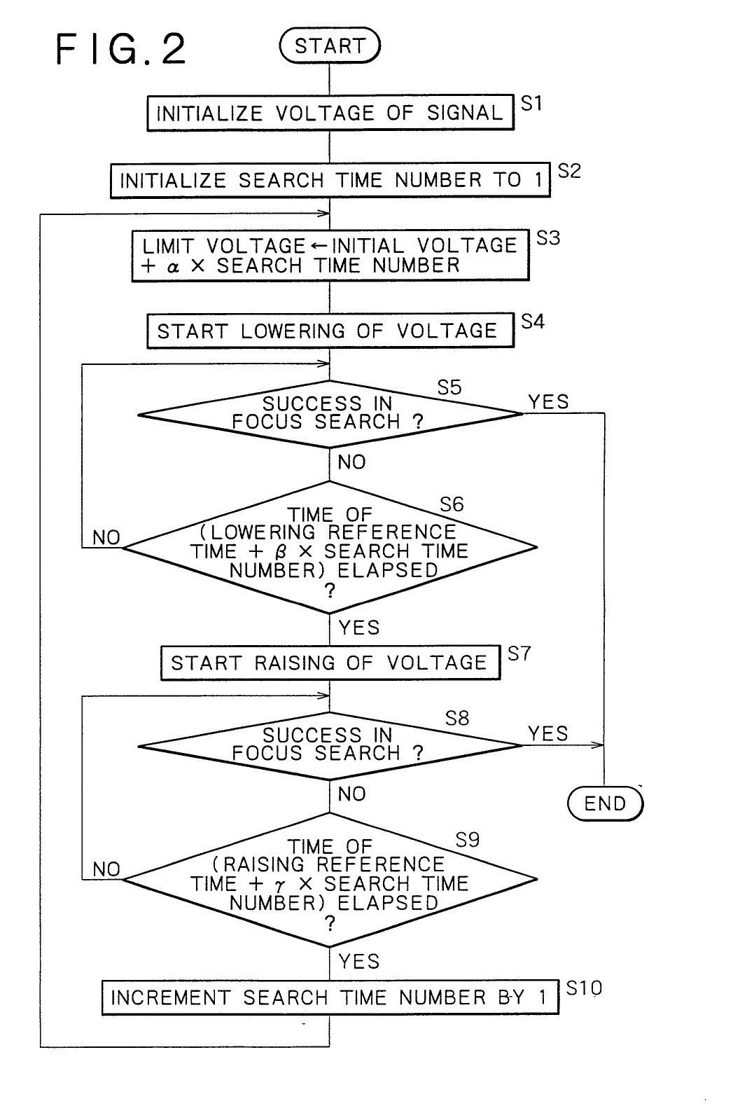

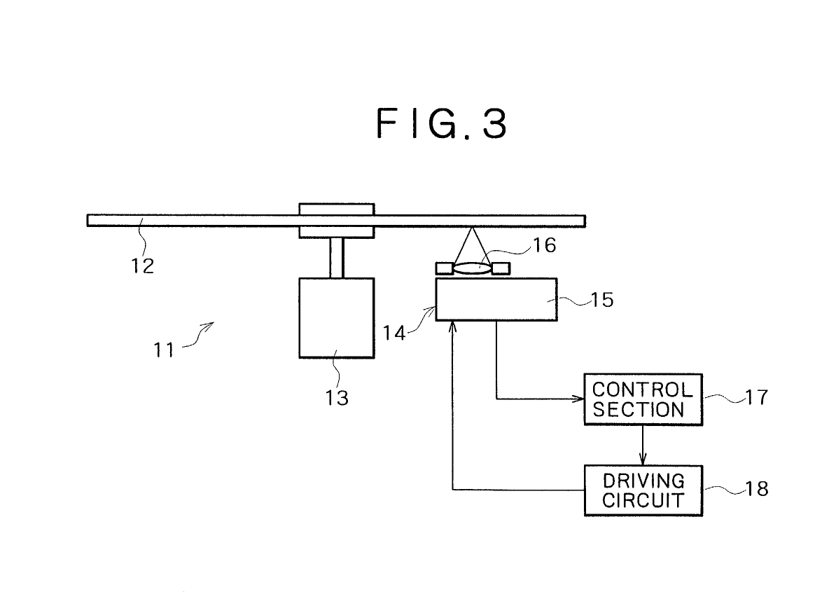

In the following, an embodiment of the present invention wherein it is applied to an optical disk recording and/or playback apparatus is described with reference to FIGS. 1 and 2. Also the optical disk recording and/or playback apparatus has such a configuration as described hereinabove with reference to FIG. 3. Therefore, the embodiment of the present invention is described with reference also to FIG. 3, However, the software used in the control section 17 is different from that of the conventional optical disk recording and/or apparatus 11 described hereinabove. More particularly, the software used causes the control section 17 to control, upon a focus search, the driving circuit 18 to supply a signal having a waveform whose amplitude and period are gradually increasing as seen in FIG. 1 to the driving mechanism 15.

FIG. 2 illustrates a detailed process of the control section 17 and the driving circuit 18 upon the focus search. Referring to FIG. 2, after the focus search is started, the voltage of the signal for the focus search is initialized in step S1. As described hereinabove, even if the signal of the initial voltage is supplied from the driving circuit 18 to the driving mechanism 15, the driving mechanism 15 does not generate driving force in the focusing direction. After the initialization of the voltage of the signal, the search time number is initialized to 1 in step S2.

Then, the control section 17 adds the product of a predetermined value α and the search time number to the initial voltage and sets a resulting value as a limit voltage in step S3, and then controls the driving circuit 18 to start lowering of the voltage of the signal in step S4. Upon such lowering of the voltage of the signal, the driving mechanism 15 starts also an operation of moving down the optical pickup 14 away from the optical disk 12. Then, while the voltage of the signal is successively lowered, the control section 17 discriminates whether or not the focus search wins a success in step S5.

If the focus search wins a success (Yes in step S5), then the control section 17 controls the driving circuit 18 to stop the supply of the signal to end the focus search and then start focus servoing. However, if the focus search does not win a success (No in step S5), then the processing advances to step S6, in which the control section 17 discriminates whether or not a time of the sum of a lowering reference time and the product of a predetermined value β and the search time number elapses. If the time of the sum does not elapse (No in step S6), then the processing returns to step S5. Consequently, the lowering of the voltage of the signal is continued until the time of the sum elapses. Then, if the control section 17 detects lapse of the time of the sum (Yes in step S6), then it controls the driving circuit 18 to now start raising of the voltage of the signal (step S7).

As the voltage of the signal rises, the driving mechanism 15 starts also an operation of raising the optical pickup 14 toward the optical disk 12. Then, while the voltage of the signal is successively raised, the control section 17 discriminates whether or not the focus search wins a success (step SS). If the focus search wins a success (Yes in step S8), then the control section 17 controls the driving circuit 18 to stop the supply of the signal to end the focus search and then start focus servoing. On the other hand, if the focus search does not win a success (No in step S8), then the control section 17 discriminates whether or not a time of a sum of a raising reference time and the product of a predetermined value γ and the search time number elapses (step S9). If the time of the sum does not elapse (No in step S9), then the processing returns to step S8. Consequently, the rising of the voltage of the signal is repeated until the time of the sum elapses.

However, if the voltage of the signal rises up to the limit voltage specified as above, then the control section 17 controls the driving circuit 18 so that the voltage of the signal may not be raised any more. Usually, the situation just described is not entered. However, if this situation is entered by some cause, then the waveform at a portion of the signal which is higher than the initial voltage does not become such a triangular waveform as seen in FIG. 1 but becomes a trapezoidal waveform, thereby to prevent the optical pickup 14 from excessively approaching the optical disk 12. If the control section 17 detects lapse of the raising time (Yes in step S9), then it increments the search time number by 1, and then the processing returns to step S3 so that the processing beginning with the setting of the limit voltage based on the increased search time number is repeated.

In the present embodiment described above, even if the optical pickup 14, the driving circuit 19 or the like has individual differences, an individual which can perform the focus search even with a signal of a low voltage wins a success in the focus search with a signal of the initial period, but another individual which can perform the forces search but with a higher voltage wins a success in the focus search with a signal of a succeeding period. Further, since several opportunities for the focus search are available before a high voltage of a signal is used, even if the focus search does not win a success with a signal of the initial period, if the focus search wins a success in one of the following several opportunities, then the objective lens 16 and the optical disk 12 do not collide with each other.

It is to be noted that, in the embodiment described above, the procedure illustrated in FIG. 2 is repeated until the focus search wins a success, and as the search time number increases. also the limit voltage and the voltage of the signal rises. However, the limit voltage of the maximum value of the voltage of the signal may be determined otherwise such that it may correspond to a maximum distance between the objective lens 16 and the optical disk 12 upon starting of the focus search. In this instance, collision between the objective lens 16 and the optical disk 12 upon focus search is prevented with certainty.

Further, while, in the embodiment described above, a triangular wave which can be generated readily by digital processing by the driving circuit 18 is used as the voltage waveform, of the signal for the focus search, some other waveform such as a sinusoidal waveform may be used instead. Further, the focus search may be performed during rotation or during stopping of the optical disk 12. Furthermore, while, in the embodiment described above, the present invention is applied to the optical disk recording and/or apparatus 11, it can be applied otherwise to an apparatus which performs at least one of playback and recording from and onto an optical recording medium other than an optical disk.

While a preferred embodiment of the present invention has been described using specific terms, such description is for illustrative purposes only, and it is to be understood that changes and variations may be made without departing from the spirit or scope of the following claims.

What is claimed is:

1. A focus search apparatus, comprising:
signal generation means for generating a signal having a gradually increasing amplitude;
driving means for receiving the signal from said signal generation means and driving an optical pickup in a focusing direction toward an optical recording medium in response to the amplitude of the received signal; and
control means for normally allowing the signal to be supplied from said signal generation means to said driving means and for discriminating whether or not said optical pickup is driven by said driving means to move into a range within which focus servoing is possible and stopping the supply of the signal from said signal generation means to said driving means if said control means discriminate that said optical pickup has moved into the range.

2. A focus search apparatus according to claim 1, wherein the amplitude has a maximum value determined therefor so as to correspond to a maximum distance between said optical pickup and the optical recording medium upon starting of the driving.

3. A focus search apparatus according to claim 1, wherein the signal has a gradually increasing period.

4. A focus search method, comprising the steps of:
driving an optical pickup in a focusing direction toward an optical recording medium with a gradually increasing amplitude; and
stopping the driving when said optical pickup reaches a range within which focus servoing is possible as a result of the driving.

5. A focus search method according to claim 4, wherein the amplitude has a maximum value determined therefor so as to correspond to a maximum distance between said optical pickup and the optical recording medium upon starting of the driving.

6. A focus search method according to claim 4, wherein the signal has a gradually increasing period.

7. An optical disk recording and/or playback apparatus, comprising:
signal generation means for generating a signal having a gradually increasing amplitude;
driving means for receiving the signal from said signal generation means and driving an optical pickup in a focusing direction toward an optical recording medium in response to the amplitude of the received signal; and
control means for normally allowing the signal to be supplied from said signal generation means to said driving means and for discriminating whether or not said optical pickup is driven by said diving means to move into a range within which focus servoing is possible and stopping the supply of the signal from said signal generation means to said driving means if said control means discriminate that said optical pickup has moved into the range.

8. An optical disk recording and/or playback apparatus according to claim 7, wherein the amplitude has a maximnum value determined therefor so as to correspond to a maximum distance between said optical pickup and the optical recording medium upon starting of the driving.

9. An optical disk recording and/or playback apparatus according to claim 7, wherein the signal has a gradually increasing period.
